(19) United States
(12) Patent Application Publication
(10) Pub. No.: US 2008/0319827 A1
(43) Pub. Date: Dec. 25, 2008

(54) MINING IMPLICIT BEHAVIOR

(75) Inventors: Dawson Yee, Bellevue, WA (US); James E. Allard, Seattle, WA (US); Steven Drucker, Bellevue, WA (US); James C. Finger, Kirkland, WA (US); Oliver R. Roup, Seattle, WA (US); David H. Sloo, Menlo Park, CA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/767,720

(22) Filed: Jun. 25, 2007

(51) Int. Cl. G06F 17/00

(52) U.S. Cl. 705/10

(57) ABSTRACT

The claimed subject matter relates to an architecture that can monitor transactions between a content consumer and a user-interface that provides the content. The architecture can also monitor environment variables that relate to a content consumption environment. From one or both of these potential sources, the architecture can identify implicit behavior on the part of the content consumer that relates to the consumption of the content. The implicit behavior can be employed to determine or infer effects of the consumed content, which can supplement, enhance, or replace conventional explicit consumer feedback.

### CROSS-REFERENCE TO RELATED APPLICATIONS

This application is related to co-pending U.S. patent application Ser. No. (MSFTP1804US) ______ entitled, “ENVIRONMENT SENSING FOR INTERACTIVE ENTERTAINMENT”, and also related to co-pending U.S. patent application Ser. No. (MSFTP1805US) ______ entitled, “AUTOMATIC CONFIGURATION OF DEVICES BASED ON BIOMETRIC DATA”, both of which are being filed concurrently. The entireties of these applications are incorporated herein by reference.

### BACKGROUND

In the domain of content consumption, including entertainment-based content, service-based content, advertisement-based content and so forth, there are a wide range of conventional mechanism commonly employed to capture user opinions, assent, or ratings with respect to various content. Well-known mechanisms include winks, nudges, pings, thumbs up/down, hot or not as well as surveys or questionnaires designed to elicit feedback from the viewer, listener, user, or other type of content consumer with respect to the consumed content. Authors or providers of this content oftentimes place great stock in the effects of the content they create, deliver, or host, which can be employed for ratings and awards as well as for costs associated with acquisition or marketing. Unfortunately, obtaining data that is both useful and accurate presents numerous challenges.

For example, most types of feedback mechanisms rely upon (and therefore require) explicit actions on behalf of the content consumer. Thus, the content consumer must explicitly participate in the survey, or manually fill out the questionnaire, whereas most content consumers choose not to do so, even when it is as simple as selecting a thumbs up to agree with the point-of-view of a particular weblog, or to check a radio button indicating the above content was helpful. Moreover, especially with more detailed information, the veracity of the responses may sometimes be questionable, whereas in many situations only bone fide responses may be useful.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The subject matter disclosed and claimed herein, in one aspect thereof, comprises an architecture that can utilize implicit behavior of a content consumer in order to assess or infer the effects of consumed content upon the content consumer. According to one aspect, the architecture can examine transactions, both input and output, between a user-interface that provides the content and the consumer who consumes the content. In accordance therewith, certain transactions can be identified as implicit behaviors, and moreover implicit behaviors that can be employed to determine an effect of the content consumption.

In accordance with an aspect, implicit behavior can be employed to determine whether a content consumer is actively consuming the content, only passively consuming, or even ignoring the content based upon, e.g., a manner in which the consumer navigates the content or the underlying user-interface. Implicit behavior can also be employed to develop a rich stochastic model with respect to the consumption of content.

According to another aspect, the implicit behavior can be obtained from an environment variable associated with the environment of the content consumer in addition or alternatively to the transactions between the content consumer and the user-interface. Thus, for example, pressing an input button to skip a music track can an implicit behavior (e.g., selected from a set of transactions with a user-interface) as can the fact that the content consumer is exercising at the time (e.g., selected from a set of environment variables).

In addition, the claimed architecture can provide data relating to the implicit behavior or a determined or inferred effect of the consumed content upon the consumer to qualifying parties, such as content authors, content providers, as well as the content consumer. In some situations, the qualifying party must employ an affiliated qualifying product or service in order to be eligible for receiving any or portions of the data.

In accordance with yet another aspect of the claimed subject matter, the architecture can be resident in or a component of the device or mechanism providing the user-interface such as an electronic device, an operating system, or a component in a software application such as a content browser. Accordingly, the architecture can readily sample information that conventional mechanisms may not be able to access.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a computer implemented system that can utilize implicit behavior to gauge an effect of consumed content.

FIG. 2 illustrates a block diagram of a computer implemented system that can employ environment variables to identify implicit behavior.

FIG. 3 depicts a block diagram of a computer implemented system that can provide various types of feedback based upon information received.

FIG. 4 illustrates a block diagram of a computer implemented system that can provide feedback to a qualifying party.

FIG. 5 is a block diagram that illustrates a computer implemented system that can intelligently employ information associated with implicit behavior as well as determined or inferred effects of the implicit behavior.

FIG. 6 depicts an exemplary flow chart of procedures that define a computer implemented method for assessing effects of consumed content upon a consumer by examining implicit behavior.

FIG. 7 is an exemplary flow chart of procedures that define a computer implemented method for determining an implicit behavior.

FIG. 8 illustrates an exemplary flow chart of procedures that define a computer implemented method for utilizing the implicit behavior or the ascertained effect.

FIG. 9 illustrates a block diagram of a computer operable to execute the disclosed architecture.

FIG. 10 illustrates a schematic block diagram of an exemplary computing environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g. card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect, feature, embodiment, or design described herein as “exemplary” is not necessarily to be construed as preferred or advantageous over other. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

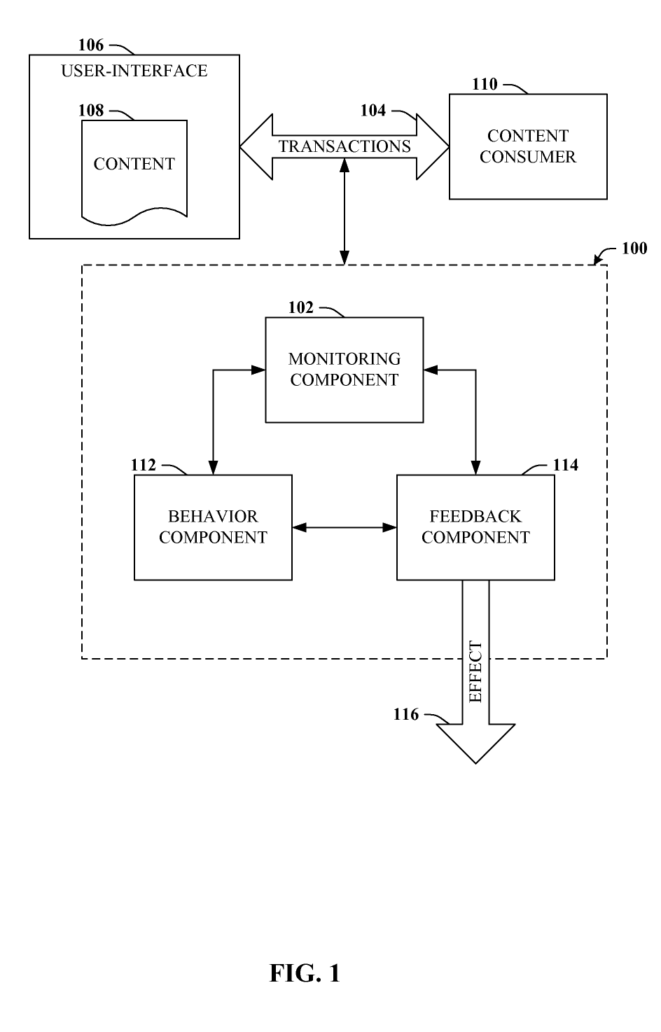

Referring now to the drawings, with reference initially to FIG. 1, a computer implemented system 100 that can utilize implicit behavior to, e.g., gauge an effect of consumed content is depicted. Generally, the system 100 can include a monitoring component 102 that can monitor transactions 104 between a user-interface 106 and a content consumer 110, wherein the user-interface 106 typically provides content 108 that is consumed by the content consumer 110. The user-interface 106 is typically an aggregate means by which a user and a device (not shown) communicate or interact. Accordingly, many different types of user-interface 106 are applicable to the claimed subject matter, even though the features of one user-interface 106 may be notably distinct from features of another user-interface 106, commonly due to distinctions between host devices or implementations.

Hence, for the sake of illustration, it is to be appreciated that the user-interface 106 can relate to a computer such as a personal computer, laptop, server/workstation, or gaming console; to an electronic multimedia device such as a television, stereo, Digital Video Recorder (DVR), Digital Versatile Disc (DVD) player, or Compact Disc (CD) player; to other electronic devices such as handheld or wearable devices including but not limited to a cellular phone, Personal Digital Assistant (PDA), remote controls, media players or recorders; as well as to software-based devices such as an operating system or an applications that runs on the host device (or host operating system) such as a multimedia player or a content browser. Many examples and/or scenarios provided herein reference a web browser, however, it should be understood that a web browser is only one example and many other types of content browsers (e.g. television browsers, music browsers, photo browsers, data browsers, etc.) as well as many different types of devices or applications altogether can applicable to the claimed subject matter.

Given the wide range of potentially suitable host devices, an associated user-interface 106 can appropriately vary, but the user-interface 106 is intended to include all or substantial portions of available input and output mechanisms by which the host device communicates or interacts with a user such as displays, speakers, keyboards/keypads, pointing devices (e.g. mouse or lightpen) as well as other input devices such as touch surfaces, gesture inputs, and so on, cursors, navigation tools, buttons, microphones, menus, LED's, etc. In accordance therewith, it is also to be appreciated that the nature of the transactions 104 can vary as well depending upon, e.g., a type of device and/or user-interface 106, however, the transactions 104 are intended to include all or substantial portions of the input to or output from the user-interface 106, including but not limited to the output of the content 108 to the content consumer 110 and the input to the user-interface 106 by the content consumer 110 whether or not the input relates directly to the content 108.

According to an aspect of the claimed subject matter, a type of content 108 can be a relevant factor. For example, suitable content 108 usually includes content 108 for which an effect of the content 108 upon the content consumer 110 can serve as pertinent feedback to, e.g., improve the quality of the content 108, tailoring the content 108 served, assessing a value of serving the content 108, and so forth. Thus, suitable content 108 generally includes, but is not necessarily limited to, advertising content 108 (e.g., banner ads, commercials, advertisements), service-based content 108 (e.g. search, mapping, weather, stocks, news/newsletter, or information/knowledge based services), or entertainment content 108 (e.g., games, music, sports, television programs, or movies).

The system 100 can also include a behavior component 112 that can examine the transactions 104 in order to identify an implicit behavior associated with consumption of the content 108. Implicit behavior generally refers to an action or event that, although not explicitly indicated by the action, can be determined or inferred to have a certain meaning or value. An implicit behavior can also be an act that provides additional context for a monitored transaction 104 or other statistic conventionally used for feedback. Furthermore, an implicit behavior can also be a response or reaction to consumed content for which the response or reaction was not explicitly solicited. A variety of illustrations relating to implicit behavior are provided infra.

Additionally, the system 100 can also include a feedback component 114 that can employ the implicit behavior to determine an effect 116 of the content 108 on the content consumer 110. The effect 116 can be an indication of approval or level of satisfaction, an indication of attention or focus, an indication of whether a desired result was achieved, an indication of a veracity of other transactions 104, even explicit transactions 104, and so on. Further illustrations relating to the effect 116 are provided herein. Furthermore, it should be appreciated and understood that components 102, 112, and 114, as well as other components described herein, can potentially reside remotely from one another and/or operate in a distributed manner.

Conventionally, it is well-known to collect explicit user-statistics such as a purchase of particular content, as well as, especially in the cases of web, television, or service-based content, downloads, accesses, or views of particular content. Such explicit statistics have a variety of limitations, but are today generally still the state-of-the art in many domains especially domains associated with advertising spending. For example, an advertising slot for a television commercial is generally directly related to a total number of viewers of a channel during a particular time segment, irrespective of whether or not 95% of the viewers happen to go to the kitchen for refreshments during the commercial break. Likewise, an advertising slot for a web-based banner ad is typically sold based upon the number of hits to a web page or the number of clicks on the banner ad, even though both types of explicit behaviors suffer dramatically from click-fraud, one very troublesome problem for the Internet today.

In other provinces, especially with entertainment-based content, but also common for advertisement-based content and service-based content, a content provider or content author may be more interested in an effect (e.g. effect 116) the content 108 has on the content consumer 110 than the cost of delivering the content 108. Again, conventional means of ascertaining such an effect are generally limited to explicit feedback, such as questionnaires, surveys, rankings and the like, all of which tend to be limited to explicit responses that may well exclude useful information, even if a content consumer 110 takes the time to provide the response. However, subscribing to the adage: actions speak louder than words, oftentimes implicit behavior can provide additional and in some cases even more accurate information than can explicit behavior, actions, or responses.

For example, content 108 providers or authors that provide web-based content 108 or serve the content 108 by way of the web sometimes have access to web server statistics that can, e.g. provide an indication of how long a content consumer 110 addressed a particular Uniform Resource Locator (URL) as well as linking information (e.g., accessed from, exited to) and other server-based information. Generally, such data can be used to calculate a popularity or reach of certain content, based upon, e.g. the length of time spent at a particular address. However, there can be important distinctions, especially from the perspective of a content 108 provider/author, between a consumer 110 who spends 30 minutes studiously reviewing the content 108 and a different consumer 110 who spends 1 minute scanning the content 108 and the next 29 minutes cooking dinner.

Web servers cannot make these distinctions, however, the system 100, operatively coupled to (or a component of), say, a web browser or an underlying operating system can potentially provide such features. For example, most any feedback associated with the explicit act of navigating to a particular URL can be augmented based upon a variety of implicit behaviors. For instance, the implicit behavior can relate to a manner in which the user-interface 106 is utilized to navigate the content 108. If transactions 104 include persistent use of the scroll bars or the page down key, such can implicitly suggest that the content consumer 110 is actively consuming the content 108 rather than passively consuming (or ignoring) the content 108. For textual-based content 108, many content consumers 110 unconsciously move a mouse cursor around in erratic patterns and/or select or highlight various portions of the text while reading. Again, such an implicit behavior can suggest that the content 108 is being consumed in a manner intended by the content provider/author, and thus has a desired effect 116.

Conversely, however, if there is no mouse cursor movement (or some other input transaction 104) for long periods of time, the user-interface 106 is minimized, a variety of other tasks are being performed simultaneously, or one of the transactions 104 is a display of a screen saver, such can be indicative that the content 108 is not actually being consumed, even though it may be “active” according to many conventional metrics. Thus, implicit behavior can be employed in many ways to supplement, refine, explain, or in some cases, even disagree with conventional metrics that rely upon explicit actions. For example, a click-thru on a banner ad can occur by mistake. Conventionally, the advertiser pays the same for this click as any other, but implicit behavior can provide a mechanism to distinguish an accidental click from a germane click.

Likewise, many content providers allow customers, users, or communities to vote or rank the content. While explicit ranking can provide a number of beneficial results, implicit behavior can be helpful as well. For example, a content consumer 110 may not care to rank content 108, however, that consumer 110 may review the content several times or attach the content 108 to an email or messenger client and deliver the content 108 to friends or colleagues, both of which are strong indicators of a level of satisfaction or approval and/or a positive effect 116 upon the content consumer 110, that is not captured by conventional ranking (or other) metrics. In addition a notion of “dwell time”, or a length of time that the content consumer 110 spends consuming the content 108, can be used in a variety of ways much more effectively than with conventional means, wherein there is little or no ability to distinguish active consumption from a content consumer 110 who left the room or otherwise ended interaction with the user-interface 106.

Moreover, implicit behavior can be utilized to determine the veracity and/or quality of an explicit ranking, rating, or questionnaire. For instance, a questionnaire that is conscientiously completed, with implicit behavior to suggest adequate time and interest was employed can be given more weight than a questionnaire with implicit behavior that suggests the selections were haphazard or random, or was given very little deliberation.

It is to be appreciated that while the implicit behaviors identified by the behavior component 112 typically relate to transactions 104 that are inputs to the user-interface 106, some implicit behaviors can be outputs from the user-interface 106, such as the activation of a screen saver, which implicitly suggests that the consumer 110 is not interacting with the user-interface 106 and/or not actively consuming the content 108. It is also to be appreciated that an implicit behavior for one type of content 108 may not be the same for other types of content 108. For instance, very few transactions 104 may be the norm for some types of content 108 such as a movie, whereas it may be indicative of inattention for others. Another instant example includes repeatedly consuming the content 108. In many cases, especially with entertainment-based content 108, such can be a sign off a high level of enjoyment or satisfaction with the content 108. However, in other cases (e.g., a how-to or troubleshooting guide), repeated consumption of the content can be a sign of inadequacies or inconsistencies in the content 108 as well as relate to a level of frustration or confusion with the consumer 110. Accordingly, the behavior component 112 can identify the implicit behavior from amongst the transactions 104 based upon a type of the content 108.

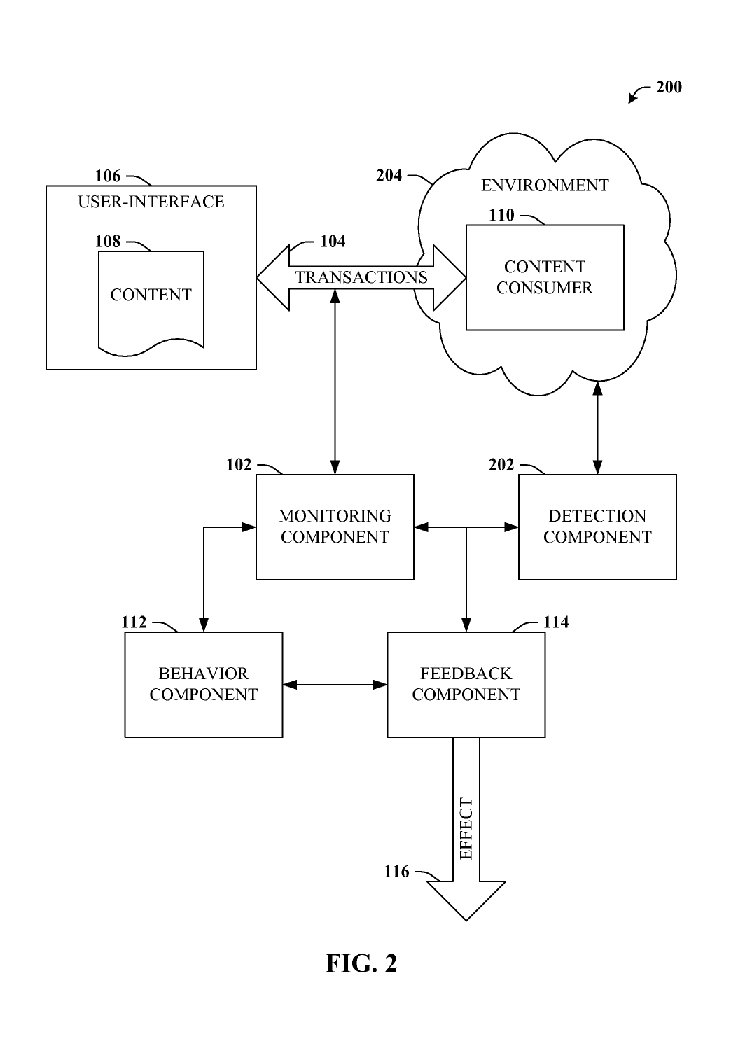

As additional examples, implicit behaviors can include a skip, pause, rewind, or speed adjustment of portions of content, a volume adjustment, consuming the content more than one time, a duration in which the content or portions of the content is reliably consumed, a manner in which the user-interface 106 is utilized to navigate the content 108, a manner in which the user-interface 106 is utilized to navigate disparate content, a manner in which the user-interface is utilized to navigate or display metadata associate with or related to the content, an action that indicates the content is of present or future interest to the consumer or a member of a social network or circle associated with the consumer, a reliable indication of attention or focus, and so on, many or all of which can be employed in connection with an environment variable as further discussed in connection with FIG. 2. In essence, implicit behaviors can relate to substantially any action, transaction, or behavior that can be indicative of an interest in the content 108. Moreover, the implicit behavior can suggest distinctions in a level of interest for some content 108 with respect to other content 108. Accordingly, the implicit behaviors can be utilized expressly for determining holistic effects 116 such as “likes”, “dislikes”, “wants to share”, “wants to remember”, “is willing to purchase” and so forth.

Turning now to FIG. 2, a computer implemented system 200 that can employ environment variables to identify implicit behavior is illustrated. In general, the system 200 can include the monitoring component 102 that monitors transactions 104, which relate to content 108, between a user-interface 106 and a content consumer 110. In addition, the system can also include the behavior component 112 and the feedback component 114, all as substantially described supra in connection with FIG. 1. The system 200 can also include a detection component 202 that can obtain environment variables from an environment 204 associated with the consumption of the content 108.

The environment 204 typically relates to the consumption of the content 108, generally including the content consumer 1 10. While the detection component 202 can include and/or can be operatively or communicatively coupled to a wide array of sensors extant in the environment 204 that can obtain environment variables, of particular interest in many cases are environment variables that relate to a biometric of the content consumer 110. However, it is to be appreciated that many other types of environment variables can exist and can be within the spirit and scope of the claimed subject matter.

More particularly, the behavior component 112 can identify an implicit behavior by examining the environment variables received by the detection component 202 in a manner similar to identifying implicit behavior from among the transactions 104 received by the monitoring component 102. In either case, the feedback component 114 can employ the implicit behavior to determine the effect 116 of the content 108 on the content consumer 110. As indicated, the environment variable can be, e.g., a biometric such as a heart rate, thermogram, brainwave pattern, sweat reading, gaze or eye focus tracking, head turning, blinking, and so on, which can be an excellent source of information regarding the effects 116 of consumed content 108. For example, an increased heart rate during what a content author hopes is a particularly riveting action sequence of a movie or video game scenario or sequence can be indicative of a successful effect 116. As another example, consider a street-side billboard, sign, newspaper vending machine, magazine stand, or the like: the detection component 202 can relay environment variables that relate to one or more of the above-mentioned content providers such as changes in stride or gait (e.g., slowing down to read a headline) as well as monitoring gaze or focus. Of course many other examples exist.

As another example, an environment variable can relate to a location of the content consumer 110, to a count of content consumers 110 in the environment 204, or even a location of the environment 204. For instance, especially with entertainment-based content 108, certain behaviors such as skipping a music track in a playlist can be indicative of a low level of interest or approval, however, additional implicit behaviors can account for factors generally excluded from such information, such as a determination of a tendency to skip a particular music track when the environment 204 includes multiple content consumers 110, or when the content consumer 110 is at a particular location, but a contrary tendency not to skip the song (and perhaps increase the volume) when the content consumer 110 is alone or when driving an automobile. Such information could be used to earmark or categorize the music track (and potentially direct marketing thereof) as “travel music” or the like.

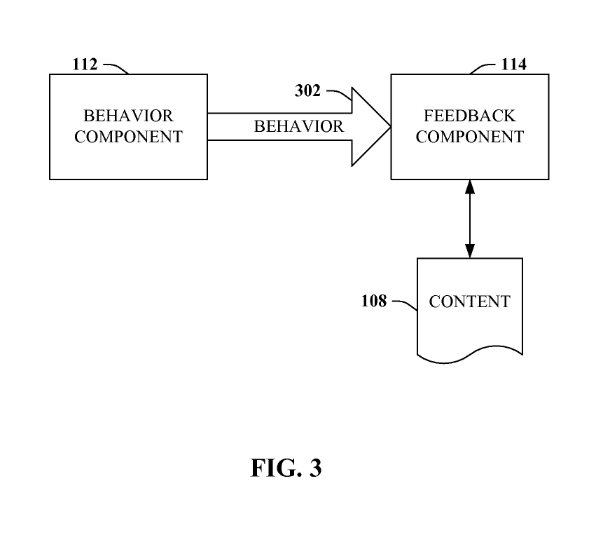

Referring to FIG. 3, a computer implemented system 300 that can provide various types of feedback based upon information received is depicted. Typically, the system 300 can include the behavior component 112 that can examine transactions between a user-interface and a content consumer as well as suitable environment variables in order to identify an implicit behavior 302. The implicit behavior 302 can be transmitted to the feedback component 114 and an effect can be determined as substantially described supra.

In accordance with one aspect of the claimed subject matter, the feedback component 114 can dynamically modify the content based upon the determined effect. In accordance with another aspect, the feedback component 114 can employ the implicit behavior to order or organize the content 108. For example, consider a content browser that maintains a history feature as well as a favorites feature. Conventionally, browser history features maintain a list of all content browsed (generally sorted by date) and browser favorites features maintains content that has been manually bookmarked (generally sorted alphabetically or by date). In contrast, the feedback component 114 can employ implicit behavior 302 to order or organize these features based upon a level of importance (e.g. an effect) rather than strictly alphabetically or by date. The level of importance can be determined based upon a variety of implicit behaviors, such as, for instance, an amount of “active” time spent browsing the content, a number of accesses of the content, other behaviors involving the content (e.g., mailing to contacts as an attachment), and so forth.

As another example, consider a service-based content provider that modifies content 108 for, say, streaming video when the feedback component 114 determines that the content consumer's attention or focus has drifted away from the content 108. Hence, a consumer may be actively consuming the streaming video initially, but then change focus to new task. Upon discovery of this event, the feedback component 114 can dynamically modify the content 108 in order to facilitate getting the consumer's attention or focus back on the content 108, such as, e.g., updating the content 108 to reflect new subject matter or material, including but not limited to subject matter or material similar to that of the new task that effectively diverted the consumer's attention. In another aspect, the feedback component 114 can employ the implicit behavior 302 in order to provide micro-targeting for ad-based content 108. For instance, advertising content can be potentially delivered to the consumer based upon a potentially more prolific and a potentially more reliable targeting mechanism: implicit behavior.

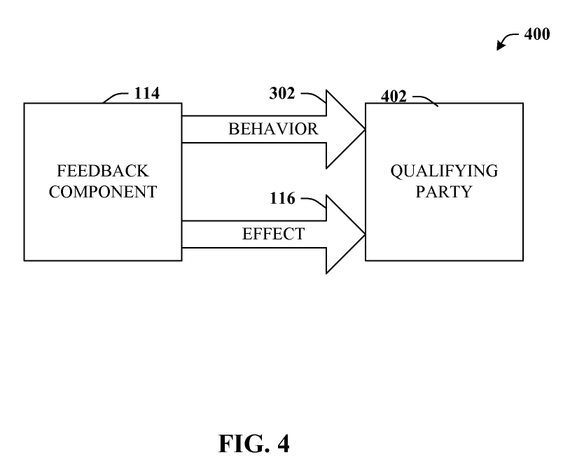

With reference now to FIG. 4, a computer implemented system 400 that can provide feedback to a qualifying party can be found. The system 400 can include the feedback component 114 that can utilize the implicit behavior 302 in order to determine an effect 116 of content upon a content consumer. In addition, the feedback component 114 can supply at least one of the implicit behavior 302 or the determined effect 116 to a qualifying party 402. It is readily apparent that implicit behavior 302 of a content consumer that arises during consumption of certain content, as well as the determined effect 116 can be of particular interest to one or both of the content author or the content provider.

Thus, according to one aspect of the claimed subject matter, the qualifying party 402 can be the content author, the content provider, or an agent of the author or provider. It is to be understood that the qualifying party 402 can also be the content consumer. Hence, in the first case, a content author can be apprised of implicit behaviors 302 or the effects 116 thereof relating to the author's content. In the second case, the content consumer can be apprised of a similar set of information, however, it may be utilized differently. For instance, while the content author may be interested in ways to improve future content, the consumer may be interested in assessing how much time was spent consuming content in a particular period of time. The fact that a television, stereo, or game console is turned on, or that a website is accessed or addressed is not always indicative that content is being consumed, and hence, may not be as relevant as implicit behavior mechanisms can be.

Moreover, especially in the case of advertisement-based content, feedback relating to implicit behavior 302 (or its effects 116) can be useful in assessing a value of delivering the consumed content. For example, if it can be determined that a click on a banner ad was a result of an errant mouse click rather than based upon an earnest desire of the content consumer, or it is observed that a particular television program produces a higher than normal active content consumption for advertising media (e.g., commercials) than other similar programs, the pricing mechanisms between an ad provider and an ad host can be suitably adjusted based upon either or both of the implicit behavior 302 or the effect 116.

According to an aspect of the claimed subject matter, the qualifying party may be required to employ an affiliated product or an affiliated service in order to be eligible as a qualifying party 402, wherein affiliated is intended to mean affiliated with the feedback component 114 and/or systems comprising the feedback component 114. For example, a content provider may be required to employ an affiliated provider service in order to be eligible to receive information from the feedback component 114. Likewise, the content author may be required to employ an affiliated content authoring tool in order to be eligible. Similarly, the content consumer may be required to employ an affiliated product or service to gain access (e.g., schedulers or time manager/summary systems, etc.). It is to be appreciated and understood that the all or portions of information supplied to the qualifying party 402 can be of an anonymous nature.

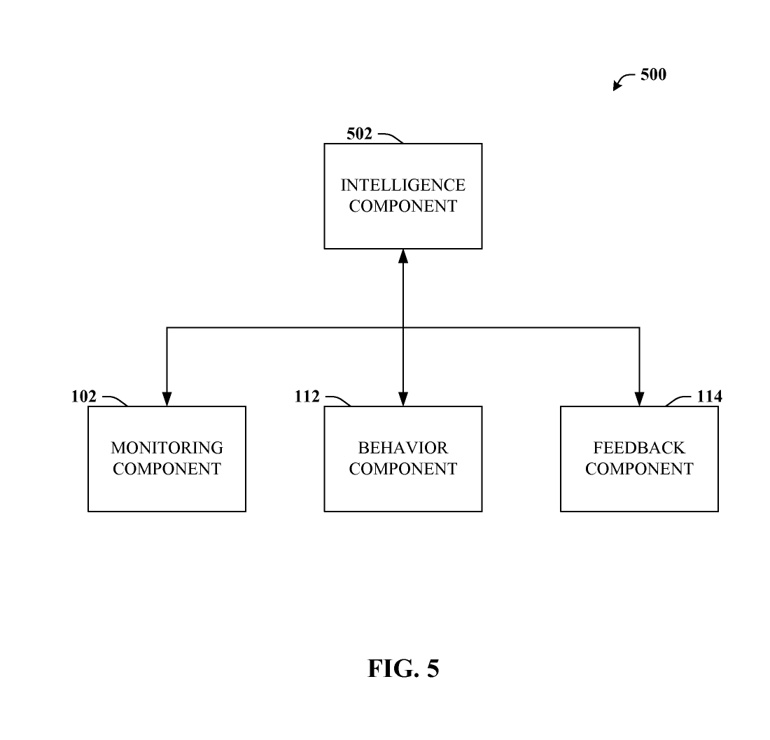

Turning to FIG. 5, a computer implemented system 500 that can intelligently employ information associated with implicit behavior and effects thereof is illustrated. The system 500 can include the monitoring component 102, the behavior component 112 and the feedback component 114 as described herein. In addition, any or all of the component 102, 112, 114 can be communicatively or operatively coupled to an intelligence component 502 that can, e.g., aid or assist with various determinations and/or inferences. For example, in accordance with an aspect the monitoring component 102 may be configured to monitor only a subset of transactions between a user-interface and a content consumer in order to, e.g., conserve system resources especially during periods of peak utilization. Accordingly, the intelligence component 502 can determine or infer what types or classes of transactions are more likely to yield suitable implicit behavior information and can, thus, lower resource utilization with little impact to effectiveness. It is to be appreciated that this is merely one example, and many other examples can exist with respect to monitoring component 102.

The intelligence component 502 can also aid or assist the behavior component 112. For example, identification of an implicit behavior can employ a large amount and a wide variety of different types of data. For instance, identifying an implicit behavior can rely upon templates, historical data, profiles, associations/relationships, aggregated data, content classification, device classification, demographic information, content models, and so on. All or portions of the aforementioned data can be employed to identify a suitable implicit behavior to aid the behavior component 112, as well as to identify which type of transactions are more likely to yield implicit behaviors in order to aid the monitoring component 102. In a similar vein, the intelligence component 502 can assist the feedback component 114 in determining an effect of the content on the content consumer by, inter alia, generating inferences based upon similar or additional data sets.

In particular, the intelligence component 502 can examine the entirety or a subset of the data available and can provide for reasoning about or infer states of the system, environment, and/or user from a set of observations as captured via events and/or data. An inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, where the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

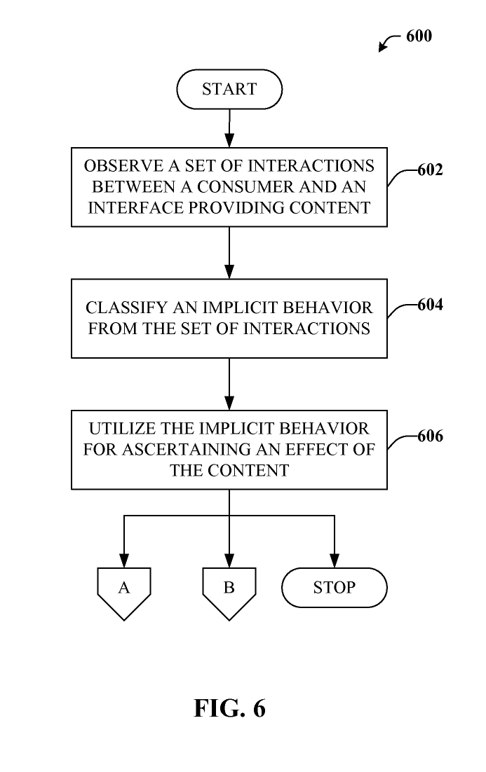

FIGS. 6, 7, and 8 illustrate various methodologies in accordance with the claimed subject matter. While, for purposes of simplicity of explanation, the methodologies are shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Turning now to FIG. 6, an exemplary computer implemented method 600 for assessing effects of consumed content by examining implicit behavior can be found. Generally at reference numeral 602, a set of interactions between a consumer of content and a user-interface providing content can be observed. For example, the set of interactions can include all or portions of input received or output directed from the user-interface, which can be inclusive of I/O related to microphones or speakers, keyboards, buttons, pointing devices, display screens, LEDs, and so on.

At reference numeral 604, one or more interactions from the set of interactions can be classified as an implicit behavior. For example, rewinding or bookmarking content, or adjusting a volume can be in many cases an implicit behavior, as can some inputs relating to a manner in which the user-interface is navigated that suggest the content is being actively and/or reliably consumed. At reference numeral 606, the implicit behavior can be utilized for ascertaining an effect of the content upon the consumer. The effect can be, for instance, an indication of approval or level of satisfaction, an indication of attention or focus, an indication of whether a desired result was achieved, an indication of a veracity of other transactions (including transactions that are not deemed to be implicit behavior), and so on.

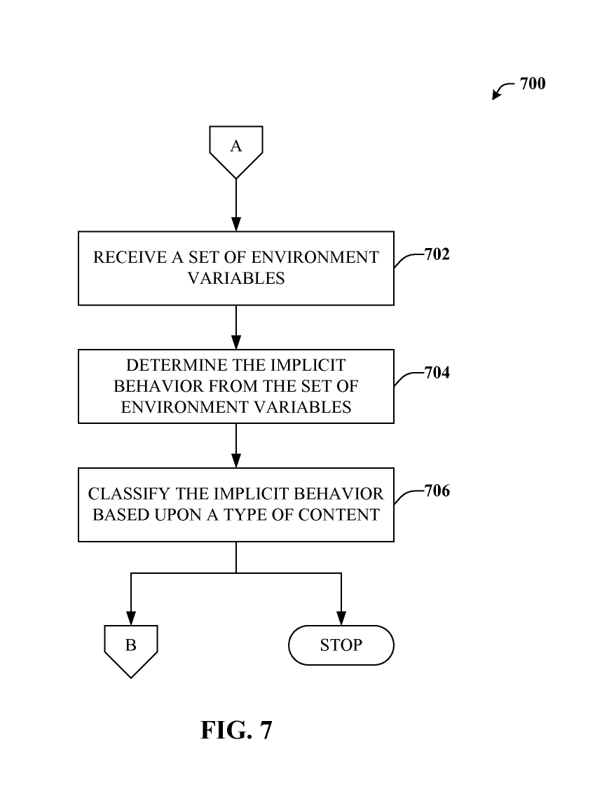

With reference to FIG. 7, an exemplary computer implemented method 700 for determining an implicit behavior is depicted. At reference numeral 702, a set of environment variables can be received. The set of environment variables can be obtained from an environment that pertains to the consumption of content, such as the content consumer's immediate environs. The environment variables can relate to a biometric of the content consumer as well as other features or factors of the environment, including locations, ambient conditions, a count of individuals in the environment, etc.

At reference numeral 704, an implicit behavior can be determined from the set of environment variables. As with the set of interactions described in connection with FIG. 6, one or more of the set of environment variables can be deemed as a relevant implicit behavior with respect to content, such as laughter, crying, sleeping, heart rate, etc. At reference numeral 706, the implicit behavior can be classified based upon a type of content. Thus, the act of crying at the conclusion of a tragic love story (e.g. entertainment-based content) might be relevant feedback for a content author, or if the content consumer where shopping online at the time such an environment variable was detected, it could be relevant to a no-run mascara or tissue provider (or another provider interested in micro-targeting), but may not be relevant in many other situations. Hence, an environment variable can be deemed to be an implicit behavior in one situation, whereas a substantially identical environment variable in a different situation would not.

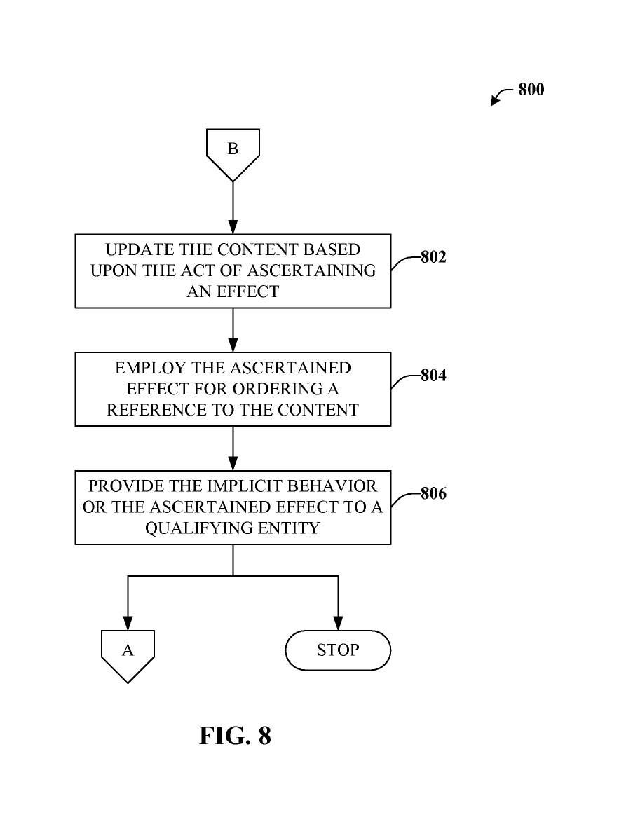

Turning now to FIG. 8, an exemplary computer implemented method 800 for utilizing the implicit behavior or the ascertained effect is illustrated. In general, at reference numeral 802, the content being consumed can be updated based upon the act of ascertaining an effect discussed at reference numeral 606 of FIG. 6 and elsewhere herein. Accordingly, if the ascertained effect is, e.g., a high level of satisfaction or approval, then similar content can be moved into a queue, for example. Likewise, if the ascertained effect is, say, dissatisfaction, the content can be modified in other suitable ways.

At reference numeral 804, the ascertained effect can be employed for ordering a reference to the content. For example, particularly in the cases where the content or the user-interface includes a history or a favorites feature, the feature can be ordered, sorted, or formatted based upon the effect suggested by an implicit behavior.

At reference numeral 806, at least one of the implicit behavior or the ascertained effect can be provided to a qualifying entity. In one aspect, the qualifying entity can be the content author, the content provider, an agent of the author or provider, or even the content consumer. In accordance with an aspect of the claimed subject matter, the qualifying entity may be an entity that employs an affiliated product or an affiliated service.

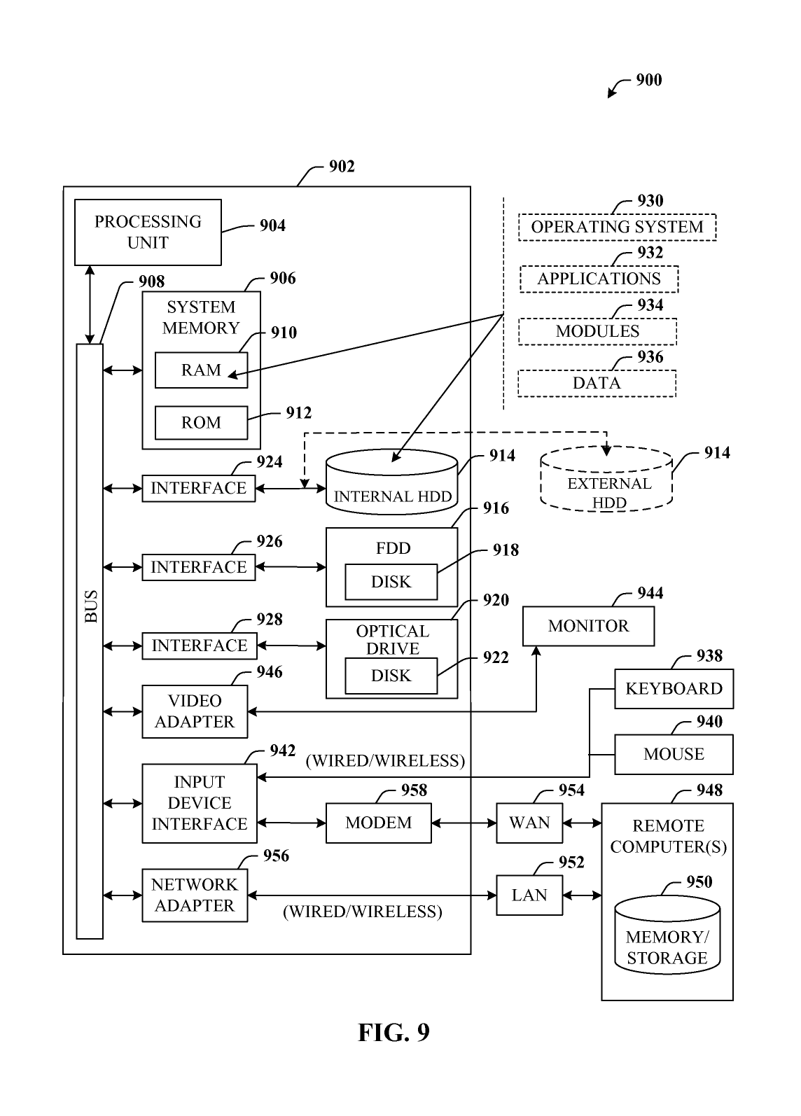

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above can be implemented in the general context of computer-executable instructions that may run on one or more computers, those skilled in the art will recognize that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g. reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the claimed subject matter.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g. a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which may connect to a global communications network, e.g. the Internet.

When used in a LAN networking environment, the computer 902 is connected to the local network 952 through a wired and/or wireless communication network interface or adapter 956. The adapter 956 may facilitate wired or wireless communication to the LAN 952, which may also include a wireless access point disposed thereon for communicating with the wireless adapter 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE802.11 (a, b, g, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 9 Mbps (802.11a) or 54 Mbps (802.11b) data rate, for example, or with products that contain both bands (dual band), so the networks can provide real-world performance similar to the basic 9BaseT wired Ethernet networks used in many offices.

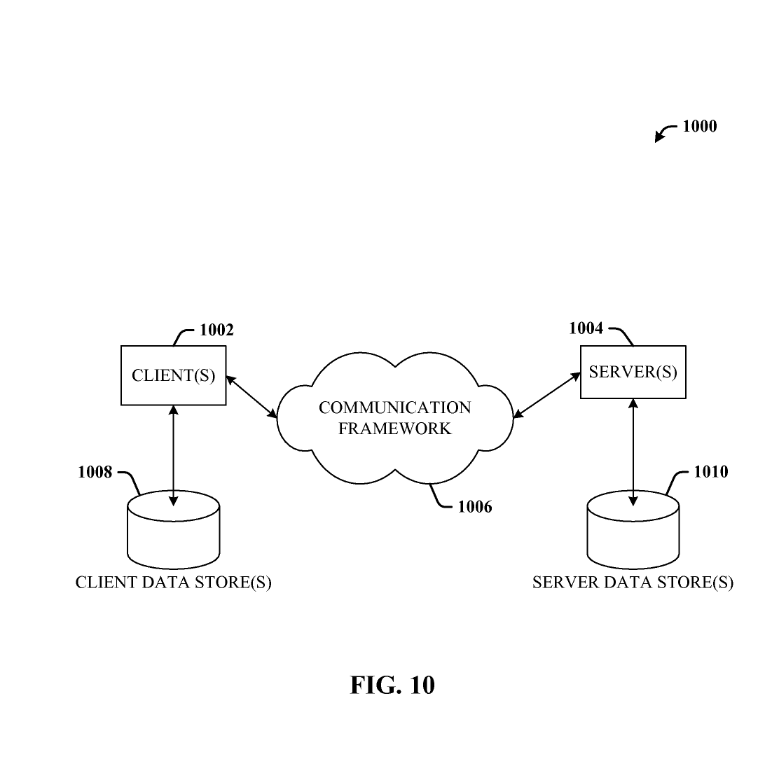

Referring now to FIG. 10, there is illustrated a schematic block diagram of an exemplary computer compilation system operable to execute the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects of the embodiments. In this regard, it will also be recognized that the embodiments includes a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A computer-implemented system that utilizes implicit behavior to gauge effects of consumed content, comprising:
a monitoring component that monitors transactions between a user-interface that provides content and a consumer of the content;
a behavior component that examines the transactions and identifies an implicit behavior associated with consumption of the content; and
a feedback component that employs the implicit behavior to determine an effect of the content on the consumer.

2. The system of claim 1, the content is at least one of entertainment content, service-based content, or advertising content.

3. The system of claim 1, the behavior component identifies the implicit behavior based at least in part upon a type of content.

4. The system of claim 1, the implicit behavior is at least one of a skip of portions of the content, a pause of portions of the content, a rewind of portions of the content, a fast forward of portions of the content, a speed adjustment of portions of the content, a volume adjustment, consuming the content more than once, a duration in which the content or portions of the content is consumed, a manner in which the user-interface is utilized to navigate the content, a manner in which the user-interface is utilized to navigate disparate content, a manner in which the user-interface is utilized to navigate or display metadata associated with or related to the content, an action that indicates the content is of present or future interest to the consumer or a member of a social network or circle associated with the consumer, a catalyst for initiating consumption of the content, a catalyst for terminating consumption of the content, or an indication of focus or attention.

5. The system of claim 1, further comprising a detection component that obtains environment variables from an environment associated with the consumption of the content.

6. The system of claim 5, the behavior component examines the environment variables and identifies an implicit behavior.

7. The system of claim 1, the feedback component dynamically modifies the content based upon the determined effect.

8. The system of claim 1, the feedback component employs the implicit behavior to order or organize the content.

9. The system of claim 1, the feedback component employs the implicit behavior for micro-targeting an advertisement.

10. The system of claim 1, the feedback component supplies at least one of the implicit behavior or the determined effect to a qualifying party.

11. The system of claim 10, the qualifying party is at least one of a provider of the content, an author of the content, or an agent of the provider or the author.

12. The system of claim 10, the qualifying party employs an affiliated product or an affiliated service to provide or to author the content.

13. The system of claim 1, or a portion thereof, is a component of an electronic device.

14. The system of claim 1, or a portion thereof, is a component of an operating system.

15. The system of claim 1, or a portion thereof, is a component of an application.

16. The system of claim 15, the application is a content browser.

17. A computer-implemented method for assessing effects of consumed content by examining implicit behavior, comprising:
observing a set of interactions between a consumer of content and a user-interface providing the content;
classifying an implicit behavior from the set of interactions based at least in part upon a type of the content; and
utilizing the implicit behavior for ascertaining an effect of the content upon the consumer.

18. The method of claim 17, further comprising:
receiving a set of environment variables; and
determining the implicit behavior from the set of environment variable.

19. The method of claim 17, further comprising at least one of the following acts:
updating the content based upon the act of ascertaining an effect;
employing the ascertained effect for ordering a reference to the content; or
providing at least one of the implicit behavior or the ascertained effect to a qualifying entity.

20. A computer-implemented system for employing implicit behavior to analyze effects of consumed content, comprising:
computer-implemented means for observing a set of transactions between a consumer of content and an interface providing the content;
computer-implemented means for detecting an implicit behavior from the set of transactions; and
computer-implemented means for employing the implicit behavior for determining an effect of the content upon the consumer.
